(19) United States
(12) Patent Application Publication
(10) Pub. No.: US 2023/0020407 A1
(43) Pub. Date: Jan. 19, 2023

(54) Aerosol Generation Device

(71) Applicant: JT International SA, Geneva (CH)

(72) Inventor: Claude Zominy, Copponex (FR)

(73) Assignee: JT International SA, Geneva (CH)

(21) Appl. No.: 17/785,541

(22) PCT Filed: Dec. 18, 2020
(86) PCT No.: PCT/EP2020/087300

§ 371 Date: Jun. 15, 2022

(30) Foreign Application Priority Data
Dec. 19, 2019 (EP) 19218307.7

(51) Int. Cl. A24F 40/48; A24F 40/60; A24F 40/46; A24F 40/57; A24F 40/44; A24F 7/00; A24F 40/42; A24F 40/10; H05B 1/02

(52) U.S. Cl. CPC A24F 40/48; A24F 40/60; A24F 40/46; A24F 40/57; A24F 40/44; A24F 7/00; A24F 40/42; A24F 40/10; H05B 1/0244; H05B 2203/016; H05B 2203/021

(57) ABSTRACT

An aerosol generating device is disclosed comprising a heater for generating an aerosol and a vapour flow passage configured to transport the generated aerosol from the heater to a mouth end of the vapour flow passage. The vapour flow passage is extendable such that a length between the heater and the mouth end is adjustable.

The present invention relates to an aerosol generation device or system, such as an electronic cigarette.

Known aerosol generation devices often use a heating component, or heater, to heat an aerosol generating liquid in order to generate an aerosol, or vapour, for inhalation by a user. The heater is typically made of a conductive material which allows an electric current to flow through it when electrical energy is applied across the heater. The electrical resistance of the conductive material causes heat to be generated as the electric current passes through the material, a process commonly known as resistive heating.

Some aerosol generation devices exhibit a large temperature drop in the generated aerosol as it travels along the air flow route between the heater and the mouthpiece, which leads to the vapour exiting the mouthpiece being very cool and not preferred by some users. In some cases vapour can condense in the device or mouthpiece before reaching a user which leads to an undesirable “wet” vapour sensation.

An object of the invention is to improve the control over the vapour temperature which exits an aerosol generation device.

According to the present invention there is provided an aerosol generating device, comprising: a heater for generating an aerosol; and a vapour flow passage configured to transport the generated aerosol from the heater to a mouth end of the vapour flow passage, wherein the vapour flow passage is extendable such that a length between the heater and the mouth end is adjustable. The vapour flow passage may be extendable to a length greater than 5 mm and less than 70 mm or less than 47 mm or less than 15 mm.

Preferably the vapour flow passage is extendable by a length of 15 to 20 mm. In this way the length of the vapour flow passage can be adjusted, which controls the amount of cooling of a generated vapour before it exits the device. Increasing the length of the vapour flow passage lowers the temperature of the vapour as it exits the device and shortening the length of the passage increases the vapour temperature as it exits the device. It should be understood that the vapour temperature is hotter as the vapour flow passage is shorter, such that the mouth end is closer to the heater. This allows a vapour to be delivered to a user at a preferred temperature and prevents condensation of the vapour within the passage, which removes the feeling of a “wet” vapour. Advantageously an adjustable vapour flow passage length allows a device to be adapted based on the ambient temperature conditions (e.g. cold weather) or when the electrical power start is lower due to a depleted battery or lower energy designs, for example.

The aerosol generation device may comprise a sliding mechanism or a screw mechanism for extending the vapour flow passage. In this way a mechanical adjustment can be integrated with the device to alter the length of the vapour route in a telescopic way. By incorporating the extendable mechanism into the device, as opposed to a consumable cartridge, the production of cartridges can be simplified and more expensive components can be used in the device. This also reduces overall production costs for devices and cartridges.

Preferably the aerosol generating device according to any preceding claim further comprising: two contact points arranged to provide a current to the heater between the contact points and a heater control arranged to change the position of a contact point on the heater to adjust the distance between the contact points through which a current is applied. In this way the temperature of the vapour as it exits the device can be further controlled by providing a control which adjusts the length of the heater through which a current passes.

Preferably the heater control comprises a sliding mechanism or a screw mechanism. In this way a mechanical adjustment can be incorporated with the device to alter the length of the heater through which a current passes. The contact points of the heater can be configured to interact with the adjustment mechanism to allow the active area of the heater to be controlled.

The aerosol generating device may further comprise a power source, wherein the heater control is configured to measure the resistance between the two contact points and adjust an applied voltage from the power source based on the measured resistance. In other words as the distance between the two contact points is adjusted, the resistance of the heater can be measured or detected in order to adjust the electrical energy received from the power source or battery. In this way electrical power supplied by the heater and thus heat generated by the heater can be adjusted such that the amount of vapour produced by the device can be controlled to be proportional to the distance between the contact points (i.e. the active length of the heater).

To put it in another way, increasing the distance between the contact points increases the length along which an electric current travels which thereby increases the effective resistance of the heater. This means that for a same applied voltage, the effective current decreases as the active length increases. Therefore in order to provide a consistent level of heating per unit length from the heater, the applied voltage from the power source would also have to increase as the active length is increased. By increasing the active length and the applied voltage proportional to the increased effective resistance, it is possible to deliver the same heating power ratio per unit of length and consequently to produce more vapour as the total active length of the heater increases.

The heater control may also adjust the length of the vapour flow passage between the heater and the mouth end. In this way a single control mechanism can be used to control both the length of the vapour flow passage and the distance through which an applied current passes through the heater. In certain applications adjusting only the length of the mouth piece may not be sufficient and the vaporization process may require further adjustment by linking the mouthpiece length with the heating element heating power (length).

Preferably the heater comprises a mesh of electrically conductive fibres configured to transport liquid through the heater by capillary action in use. In this way the heater mesh provides a wicking function to the heater such that an aerosol generating liquid can be effectively drawn onto the heater for vaporisation. The conductive fibres may be sintered mesh of metal, preferably steel fibres.

Mesh heaters are known to produce particularly cool vapours which can be undesirable to some users. Therefore by combining a mesh heater with an extendable vapour flow passage can achieve the advantages of a mesh heater (for example combined wicking and heating functionality) while still providing a desirable vapour temperature for a user.

Preferably the aerosol generating device comprises a mouthpiece which provides at least a portion of the vapour flow passage; wherein the mouthpiece is extendable to adjust the length of the vapour flow passage between the heater and the mouth end. In this way the distance between the heater and the mouth end of the vapour flow passage can be easily and intuitively adjusted by a user.

Preferably aerosol generating device comprises a consumable cartridge and the consumable cartridge comprises the mouthpiece. In this way the extendable mouthpiece can specifically complement the consumable cartridge and the aerosol generating liquid provided within. For example it may be desirable for the vapour of some aerosol generating liquids to be cooler or hotter than a typical temperature range, and specific mouthpiece that matches a consumable cartridge allows a wider range of vapour exit temperatures to be provided by the device.

Preferably the heater comprises a planar sheet of electrically conductive fibre mesh. In this way the planar sheet provides a large surface for aerosol generating liquid that has been wicked onto the sheet to be easily vaporised. Since a planar mesh can provide a large aerosol generating surface it is particular important for the temperature of the large volume of vapour exiting the device to be well-controlled.

Preferably the aerosol generating device further comprises a heater cradle for supporting the heater within the device; wherein the heater cradle comprises: two parts which meet at an interface which runs along a length of the cradle; wherein the heater is supported within a longitudinal gap at the interface between the two heater cradle parts. In this way a sandwich structure is provided in which the heater is held between the two parts of the cradle. This allows the aerosol generated liquid to be drawn onto the heater from the edges of the heater. The heater cradle may also act as a vaporisation chamber which is configured to collect aerosol generated from the heater within the inner spaces of the two cradle parts. One or more airflow channels are preferably provided in the cradle to direct air from outside the device toward the mouth end of the aerosol generation device.

Preferably the aerosol generating device further comprises a liquid store positioned around the heater cradle such that liquid is drawn from the liquid store to the heater by capillary action through the heater. In this way aerosol generating liquid from the liquid store can come into contact with the edge of the heater and by drawn onto the heater.

Embodiments of the invention are now described, by way of example, with reference to the drawings, in which:

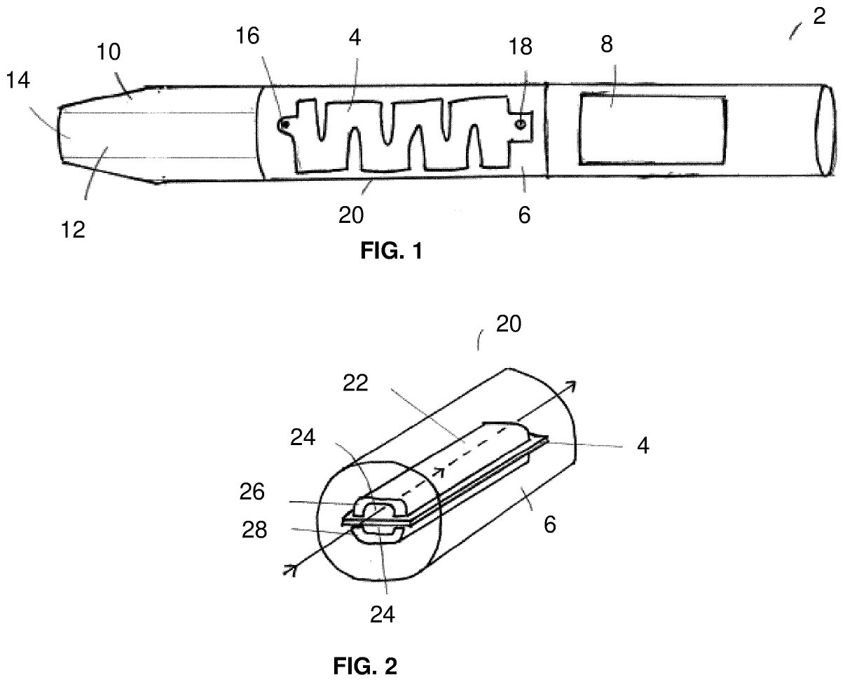

FIG. 1 is a schematic view of an aerosol generation device of the invention;

FIG. 2 is a schematic view of a vaporizer with a heating element in an embodiment of the present invention;

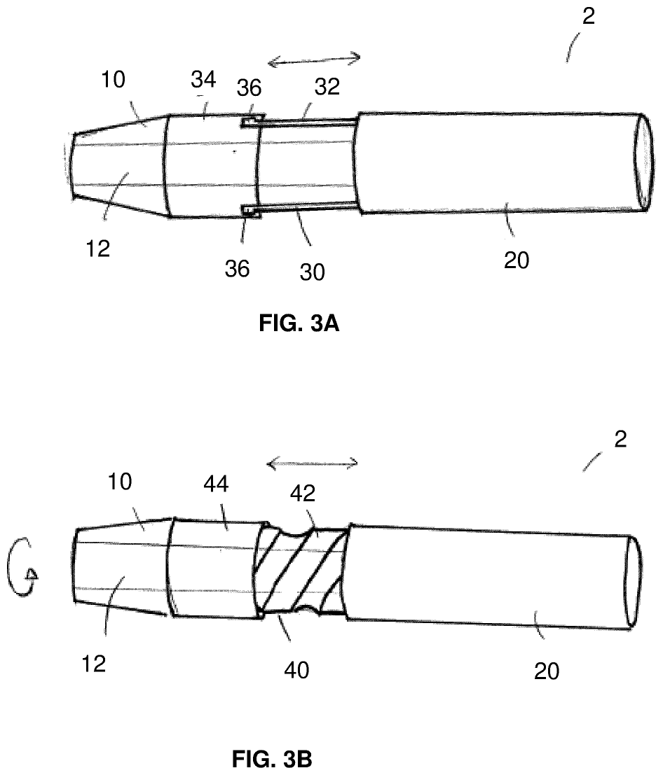

FIG. 3A is a schematic view of an extendable mechanism in a first embodiment of the invention;

FIG. 3B is a schematic view of an extendable mechanism in a second embodiment of the invention;

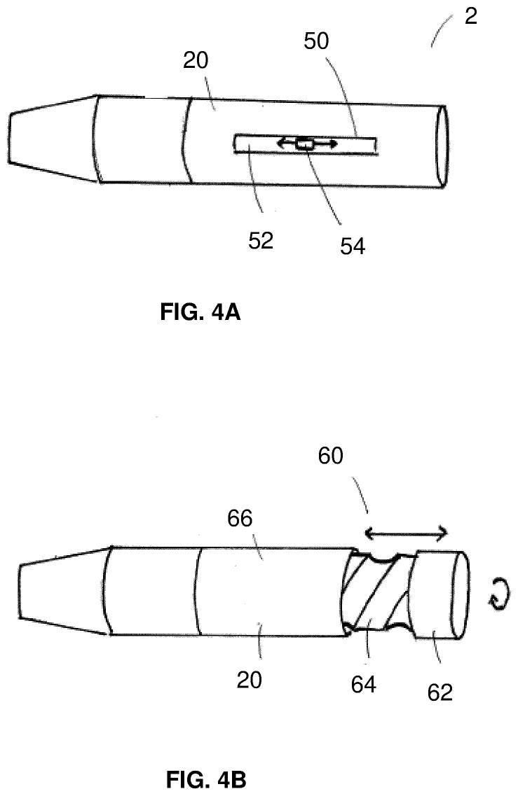

FIG. 4A is a schematic view of a heater control in a third embodiment of the invention;

FIG. 4B a schematic view of another heater control in a fourth embodiment of the invention;

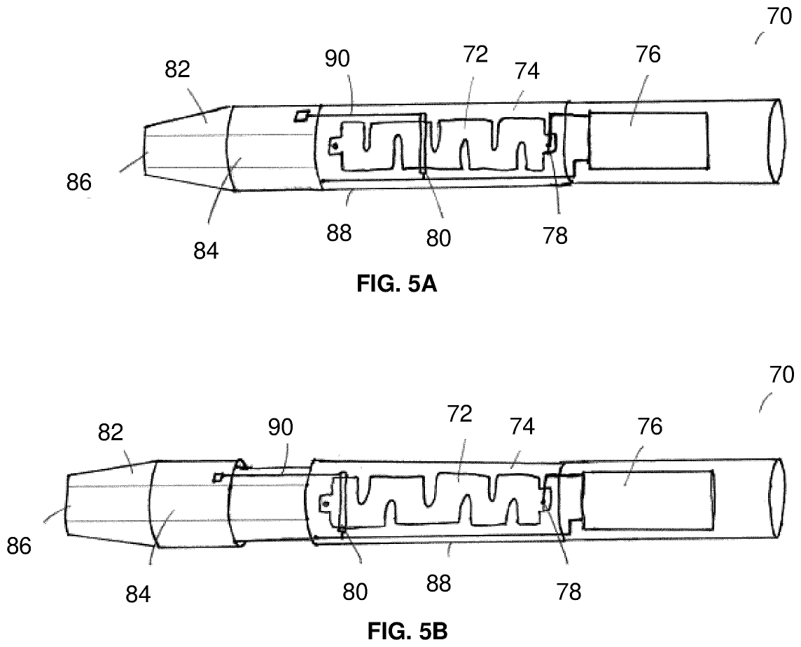

FIG. 5A is a schematic view of an aerosol generation device of the invention in a shorted configuration;

FIG. 5B is a schematic view of an aerosol generation device of the invention in an extended configuration;

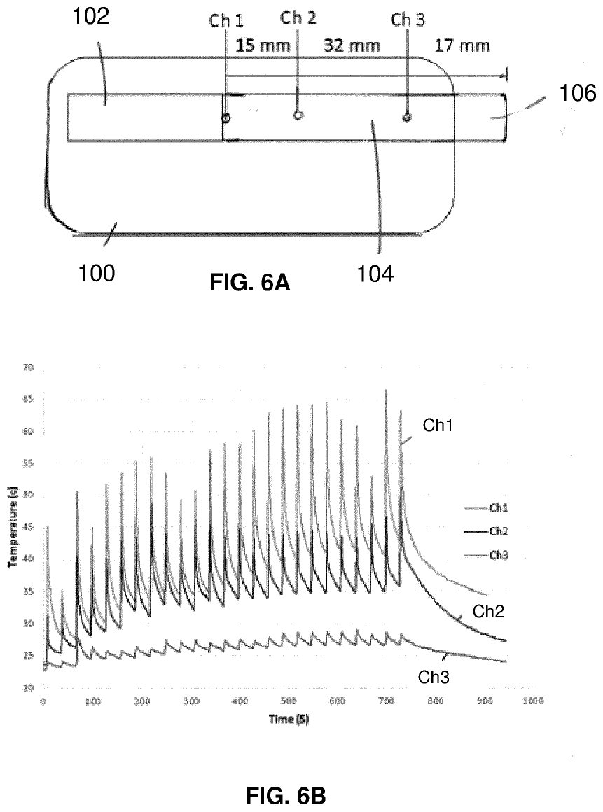

FIG. 6A is a schematic of an aerosol generation device; and

FIG. 6B is a graph representing operating temperature measurements taken at set distances in the aerosol generation device of FIG. 6A.

FIG. 1 shows an aerosol generating device 2 comprising a heater 4 arranged to receive an aerosol generating liquid from a liquid store 6. The heater 4 is also configured to receive electrical energy from a battery 8, or other form of power source, in order to generate heat. The battery 8 is arranged at one end of the heater 4, and a mouthpiece 10 is arranged at the opposite end of the heater 4 away from the battery 8. The heater 4 and liquid store 6 are provided in a vaporizer 20 as described in further detail by reference to FIG. 2.

Aerosol is generated by heating the liquid that has been drawn onto the heater 4. When a user inhales from the mouthpiece 10 of the device 2, the generated aerosol/vapour travels through a channel 12, or vapour flow passage, that connects the heater 4 to a mouth end 14 of the device 2. The vapour cools as it flows along the channel 12, and the length of the channel 12 is configured such that the temperature of the vapour as it exits the device 2 is desirable to a user. A typical length of a vapour flow passage is around 40 mm, and the channel 12 may have a constant cross-sectional area or have tapered sides.

The heater 4 may include an electrically conductive mesh having two electrical contacts 16 and 18 which are connected to terminals in the battery 8. The mesh provides a wicking function to the heater 4 by drawing liquid from the liquid store 6 by capillary action such that the surface of the mesh is wetted with the liquid. In use an electric current passes through the heater 4 between the electrical contacts 16 and 18, which causes the mesh to generate heat. The heater 4 also includes a plurality of slots in the mesh, which are arranged to cause an electric current to follow a serpentine path as it flows between the two electrical contacts 16 and 18. The liquid on the surface of the mesh is subsequently heated by the mesh to form an aerosol for inhalation.

FIG. 2 shows a schematic view of the vaporizer 20 comprising the heater 4, a liquid store 6 and a heater cradle 22. The vaporizer 20 is configured to be set in the aerosol generating device 2. The heater cradle 22 is arranged to collect aerosol generated from the heater 4. One or more airflow channels 24 is also provided in the heater cradle 22, where the airflow channel 24 is configured to, on user inhalation, direct air from outside the vaporizer 20 through the channel 12 and toward the mouth end 14 of the aerosol generation device 2.

The heater 4 is mounted in the heater cradle 22, which includes an upper cradle part 26 placed above the top major side of the heater 4 and a lower cradle part 28 placed below the lower major side of the heater 4 such that the heater 4 is held between the two cradle parts. The cradle 22 acts as a vaporisation chamber which is configured to collect generated aerosol within the inner spaces of the two cradle parts 26 and 28.

One or more edges of the heater 4 are exposed to the liquid store 6 which surrounds the heater cradle 22 and the heater 4. The edges of the heater 4 may extend beyond the outer limits of the heater cradle 22, or alternatively the upper and lower cradle parts 26 and 28, when constructed, form a gap between the two cradle parts which allows aerosol generating liquid from the liquid store 6 to come into contact with the heater edge, whereby the liquid is drawn further across the heater 4 via capillary action.

FIG. 3A shows a first extending mechanism of the invention, in which the mouthpiece 10 is configured to slide away from and toward the vaporizer 20 of the device 2. The sliding mechanism 30 comprises an inner casing 32 and an outer casing 34. The inner casing 32 is fixed relative to the vaporizer 20 and the outer casing 34 is fixedly connected to the mouthpiece 10. The outer casing 34 is configured to slide over the inner casing 32 toward and away from the vaporizer 20 to shorten or lengthen the vapour flow path/channel 12 respectively. The inner casing 32 also has a lip 36 which limits the extension of the sliding mechanism 30. A seal may be arranged at an interface between the inner casing 32 and the outer casing 34 which provides a frictional resistance to the sliding mechanism 30 such that a desired channel 12 length can be maintained during use.

FIG. 3B shows a second extending mechanism of the invention, in which the mouthpiece 10 is configured to twist away from and toward the vaporizer 20 of the device 2. The screw mechanism 40 comprises an inner threaded portion 42 and an outer threaded portion 44. The inner threaded portion 42 is fixed relative to the vaporizer 20 and the outer threaded portion 44 is fixedly connected to the mouthpiece 10. The outer threaded portion 44 is configured to twist over the inner threaded portion 42 toward and away from the vaporizer 20 to shorten or lengthen the vapour flow path/channel 12 respectively. Similar to the first extending mechanism, a seal may be provided between the inner threaded portion 42 and the outer threaded portion 44 to provide a frictional resistance to the screw mechanism 40 such that the mouthpiece 10 is held at a chosen position away from the vaporizer 20 to fix the length of the vapour flow passage 12 during use. In another example a roller screw mechanism may be used to extend the length of the channel 12.

The extending mechanisms described in FIGS. 3A and 3B can for example allow the length of the vapour flow passage to be 30 mm to 50 mm. It should be clear that the inner casing/threaded portion and outer casing/threaded portion may be switched such that the inner part is connected to the mouthpiece and the outer part is connected to the vaporizer portion of the device.

FIG. 4A shows a first heater control 50 of the invention, in which a slidable heater control 50 adjusts the length of heater 4 through which an applied current is passed. The heater control 50 has a groove 52 in which a button 54 is configured to slide along in order to control the active length of the heater 4. The active length of the heater 4 is defined as the length of the heater through which an applied current passes, which in turn determines the portion of the heater which is resistively heated. The sliding button 54 provided on the external surface of the device is connected to an internal sliding contact on the heater 4. The internal sliding contact may be provided on the heater cradle 22 and configured to be in contact with the heater 4 sandwiched within the cradle 22.

The heater 4 may have one electrical contact in a fixed position and the other electrical as the internal sliding contact. Alternatively both electrical contacts can be configured to be slidable, where movement of the button 54 causes the two electrical contacts to slide toward or away from each other in order to adjust the active length of the heater 4.

FIG. 4B shows a second heater control 60 of the invention, in which the heater control 60 is adjusted using a screw mechanism. A dial 62 is provided in the heater control 60, which can be rotated to adjust the length of heater 4 through which an applied current is passed. The rotation of the dial 62 causes an internal electrical contact of the heater to move along the length of the heater, similar to the heater control described above.

In FIG. 4B the dial 62 is provided on an externally threaded portion 64 which screws in and out of an internally threaded casing 66, in which the vaporizer 20 is provided. The screw action of the second heater control 60 thus also causes the length of the device 2 to be adjusted. Alternatively a roller screw mechanism can be used where rotation of the 62 does not change the length of the device 2 and only causes linear displacement of the internal electrical contact.

In use the heater control 50 or 60 can be configured to measure the resistance between the active length of the heater 4 and adjust an applied voltage from the battery 8 based on the measured resistance (i.e. effective resistance) of the heater 4. Similar to the heater control described for FIG. 4A the heater 4 may have one electrical contact in a fixed position and the other electrical as the internal sliding contact. Alternatively both electrical contacts can be configured to be slidable, where movement of the dial 62 causes the two electrical contacts to move toward or away from each other in order to adjust the active length of the heater 4.

In some cases increasing the active length of the heater causes an applied current to travel a longer distance across the heater which thereby increases the heating area of the heater and in turn causes the device to generate more vapour. The generated vapour cools as it travels along the vapour flow passage, but it should be understood that the average temperature of a larger volume of generated vapour will cool less than the average temperature of a smaller volume of vapour as it travels along a same distance. For this to occur, the resistive properties of the preferential current path in the heater (e.g. the solid wire) may be selected to be low such that adjusting the active length of the heater would not significantly affect the overall resistance of the heater between the contact points.

In other cases increasing the length increases the Ohmic resistance which thereby decreases the current for a same given voltage. A lower current would therefore generate a lower temperature and thus less heat from the heater and less vapour from the device. Based on the length change of the heater, the Ohmic resistance can be measured (for example by measuring the change in resistance) between the two contact points to compensate this phenomenon. In order to produce an amount of vapour proportional to the active length of the heater (i.e. where increased active length leads to an increased amount of vapour), the applied voltage can then be adjusted based on the measured Ohmic resistance between the two contacts points. This means that the electrical power can then be adjusted in order to deliver the same heating power ratio per millimetre of length (or surface) which allows a device to produce more vapour as the total active length of the heater is increased. It should be clear that measuring the Ohmic resistance would not be intended to control the temperature in these cases but to adjust the heating power per unit of length as desired. In this way, it is possible to deliver the same heating power ratio per unit if length and subsequently to produce more vapour as the total active length of the heater increases.

Therefore it should be understood that there are many parameters or factors such as the effective resistance of the heating element, the resistive properties of the preferential current path, the heating power, or the active length through which current flows which may affect the temperature control and aerosol generation of a device.

FIGS. 5A and 5B show a schematic view of an aerosol generating device 70 in another embodiment of the invention. FIG. 5A shows the device 70 in a closed, or shortened, configuration and FIG. 5B shows the device in an extended, or lengthened, configuration.

The aerosol generating device 70 comprises a heater 72 configured to generate an aerosol by resistively heating an aerosol generating liquid received from a surrounding liquid store 74. A battery 76 is provided in the device 70 to supply electrical energy to the heater 72, where the terminals of the battery 76 are connected to a first fixed electrical contact 78 and a second sliding electrical contact 80 of the heater 72. The first electrical contact 78 is arranged at the end of the heater 72 near to the battery 76, and the second electrical contact 80 is arranged along the length of the heater 72 away from the battery 76. The second sliding electrical contact 80 is configured to slide along the length of the heater 72 to increase/decrease the distance between the first and second electrical contacts 78 and 80, which sets the length of heater 72 through which an applied current passes.

The heater 72 and the liquid store 74 are set within a vaporizer 88 similar to that described in reference to FIG. 2. The device 70 further comprises a mouthpiece 82 which surrounds a channel 84 through which aerosol generated by the heater 72 can flow from the vaporizer 88 to a mouth end 86 of the device 70. In use the aerosol will cool as it travels along the channel 84.

The device 70 also includes an extension mechanism, which may preferably be a sliding mechanism 30 or a screw mechanism 40 as described in reference to FIGS. 3A and 3B. A roller screw mechanism may also be used. In this embodiment the extension mechanism is used to simultaneously control the length of the vapour flow passage, or channel 84, as well as the length of heater 72 through which an applied current flows. In other words the extension mechanism acts combines both the adjustment of the mouthpiece length and the adjustment of the active heater length to act as both a cooling length control (where the cooling is provided by the channel 84) and a heater control.

As the device 70 moves between the shortened configuration in FIG. 5A to the extended configuration in FIG. 5B, the mouthpiece 82 is extended away from the vaporizer 88 such that the length of the channel 84 is increased. This extension therefore increases the length of the vapour flow passage through which generated aerosol from the heater 72 must travel before reaching the mouth end 86.

A control arm 90 is fixedly attached to the mouthpiece 82 and the second sliding electrical contact 80 and rigidly connects the two components. When the extension mechanism is used to extend the mouthpiece 82 away from the heater 72, the control arm 90 pulls the second sliding contact 80 toward the opposite end of the heater 72 away from the first contact 78 which in turn increases the length of heater 72 through which an electric current may flow. Conversely as the mouthpiece 82 is pushed from an extended configuration toward the heater 72, the second electrical contact 80 is pushed by the control arm 90 toward the first contact 78 thereby shortening the length of heater through which current may pass.

FIG. 6A shows a schematic of an aerosol generation device 100 comprising a wick and heater 102 and a vapour flow passage, or mixing chamber, 104 that is arranged to transport aerosol generated from the wick and heater 102 to be inhaled by a user via an extendable mouthpiece 106 of the vapour flow passage 104.

FIG. 6B shows a vapour temperature versus time graph representing vapour temperature measurements taken from set points along an operating device, depicted in FIG. 6A. In operation the heater receives a pulsed current from a power source in the aerosol generation device 100 which in turn causes the heater to generate pulses of heat to heat the wick and generate aerosol. Temperature measurements were taken at a first point Ch1, a second point Ch2, and a third point Ch3 along the vapour flow passage 104 which correspond to measurement lines Ch1, Ch2 and Ch3 on the graph. The first point Ch1 is at or close to the wick and heater 102 and therefore would indicate the immediate vapour temperature as it is generated and enters the vapour flow passage 104. The second point Ch2 is set approximately 15 mm away from the first point Ch1, and the third point Ch3 is set approximately 32 mm away from the second point Ch2. The mouthpiece 16 where vapour exits the aerosol generation device is provided a further 17 mm away from the third point Ch3.

As can be seen in FIG. 6B a peak temperature is reached when a current pulse is provided and the vapour temperature decreases as vapour moves along the vapour flow passage. For example at a time of approximately 10 seconds, the vapour temperatures are approximately 45° C. at the first point Ch1, 32° C. at the second point Ch2 and 23° C. at the third point Ch3. Another example at a time of approximately 480 seconds show vapour temperatures of approximately 63° C. at the first point Ch1, 43° C. at the second point Ch2 and 27° C. at the third point Ch3. It should be understood that the decrease in vapour temperature is most significant in between the first point Ch1 and the second point Ch2, and is approximately a decrease of 0.9 to 1.3° C. per mm. The decrease in temperature between the second point Ch2 and the third point Ch3 is approximately 0.5 to 0.8° C. per mm. Therefore it has been shown that the vapour temperature in the vapour flow passage 104 is highly dependent on the distance away from the wick and heater 102, where the vapour temperature decreases at a rate of approximately 1° C. per mm away from the wick and heater 102.

It should be appreciated that the cooling characteristics of a vapour flow passage would also be dependent on the design of the vapour flow passage and mouthpiece itself. For example if the diameter of the vapour flow passage and/or mouthpiece is smaller then the decrease in temperature along the vapour flow passage would be smaller. Similarly if the diameter of the vapour flow passage is larger then heat from the vapour will be able to dissipate more easily, which means that the rate of temperature decrease in the vapour flow passage would be greater.

Dependent of the design of the vapor flow passage, it should be noted that the temperature variation along the longitudinal axis will not always follow a linear rule. Therefore it also be understood that the cooling or temperature control properties of a vapour flow passage and mouthpiece can be modified according to design or operational requirements.

1. An aerosol generating device, comprising:
a heater for generating an aerosol; and
a vapour flow passage configured to transport the generated aerosol from the heater to a mouth end of the vapour flow passage,
wherein the vapour flow passage is extendable such that a length between the heater and the mouth end is adjustable.

2. The aerosol generation device according claim 1 comprising a sliding mechanism or a screw mechanism for extending the vapour flow passage.

3. The aerosol generating device according to claim 1 further comprising: two contact points arranged to provide a current to the heater between the contact points; and
a heater control arranged to change the position of a contact point on the heater to adjust the distance between the contact points through which a current is applied.

4. The aerosol generating device according to claim 3 wherein the heater control comprises a sliding mechanism or a screw mechanism.

5. The aerosol generating device according to claim 3 further comprising a power source, wherein the heater control is configured to measure the resistance between the two contact points and adjust an applied voltage from the power source based on the measured resistance.

6. The aerosol generating device according to claim 3, wherein the heater control is further configured to adjust the length of the vapour flow passage between the heater and the mouth end.

7. The aerosol generating device according to claim 1 wherein the heater comprises a mesh of electrically conductive fibres configured to transport liquid through the heater by capillary action in use.

8. The aerosol generating device according to claim 1 wherein the device comprises a mouthpiece defining at least a portion of the vapour flow passage; wherein the mouthpiece is extendable to adjust the length of the vapour flow passage between the heater and the mouth end.

9. The aerosol generating device according to claim 8 wherein the aerosol generating device comprises a consumable cartridge and the consumable cartridge comprises the mouthpiece.

10. The aerosol generating device according to claim 1 wherein the heater comprises a planar sheet of electrically conductive fibre mesh.

11. The aerosol generating device of claim 10 further comprising a heater cradle for supporting the heater within the device; wherein the heater cradle comprises:
two parts which meet at an interface which runs along a length of the cradle; wherein the heater is supported within a longitudinal gap at the interface between the two heater cradle parts.

12. The aerosol generating device of claim 11 further comprising a liquid store positioned around the heater cradle such that liquid is drawn from the liquid store to the heater by capillary action through the heater.
